(19) United States
(12) Patent Application Publication
(10) Pub. No.: US 2025/0142211 A1
(43) Pub. Date: May 1, 2025

(54) NON-DESTRUCTIVE MULTIPLE LAYERS CROSS-SECTION FIB-LIKE VISUALIZATION

(71) Applicant: Orbotech Ltd., Yavne (IL)

(72) Inventors: Jonathan Azogui, Beer Sheva (IL); Nachum Yoav, Rehovot (IL)

(21) Appl. No.: 18/426,610

(22) Filed: Jan. 30, 2024

Related U.S. Application Data
(60) Provisional application No. 63/546,250, filed on Oct. 30, 2023.

(51) Int. Cl. H04N 23/67; H04N 23/55; H04N 23/951

(52) U.S. Cl. CPC H04N 23/671; H04N 23/55; H04N 23/951

(57) ABSTRACT

The system includes a processor in electronic communication with a structured light assembly and an imaging assembly. The structured light assembly is configured to project a structured light pattern onto a workpiece, wherein the workpiece is a multilayer structure. The imaging assembly is configured to capture a plurality of structured light images of the workpiece, wherein each of the plurality of structured light images is captured with the imaging assembly being focused at a different height relative to the workpiece. The processor is configured to generate a cross-sectional image of the workpiece based on the plurality of structured light images received from the imaging assembly.

### CROSS-REFERENCE TO RELATED APPLICATIONS

This application claims priority to the provisional patent application filed Oct. 30, 2023, and assigned U.S. Appl. No. 63/546,250, the disclosure of which is hereby incorporated by reference.

### FIELD OF THE DISCLOSURE

This disclosure relates to inspection systems and, more particularly, to inspection of transparent semiconductor components in electronics manufacturing.

### BACKGROUND OF THE DISCLOSURE

Evolution of the electronics manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for an electronics manufacturer.

Inspection processes are used at various steps during electronics manufacturing to detect defects on wafers, electronic devices, or electrical circuits to promote higher yield in the manufacturing process and, thus, higher profits. Inspection has always been an important part of fabricating electronic devices such as integrated circuits (ICs), flat panel displays (e.g., organic light emitting diode on silicon (OLEDoS) display panels), and printed circuit boards (PCBs), including assembled PCBs. However, as feature dimensions decrease, inspection becomes even more important to the successful manufacture of acceptable electronic devices because smaller defects can cause devices and assemblies to fail. For instance, as feature dimensions decrease, detection of defects of decreasing size has become necessary because even relatively small defects may cause unwanted aberrations in the devices.

Even for transparent multilayer structures, it can be difficult for inspection processes to detect internal defects (e.g., between layers). Some existing methods rely on a focused ion beam (FIB) impinging on while capturing images. However, the FIB is destructive of the workpiece because it drills down further depths for imaging.

Therefore, what is needed is a non-destructive method for detecting internal defects.

### BRIEF SUMMARY OF THE DISCLOSURE

An embodiment of the present disclosure provides a method comprising projecting a structured light pattern onto a workpiece, wherein the workpiece is a multilayer structure. The method may further comprise capturing a plurality of structured light images of the workpiece using an imaging assembly, wherein each of the plurality of structured light images is captured with the imaging assembly being focused at a different focal depth relative to the workpiece. The method may further comprise generating a cross-sectional image of the workpiece based on the plurality of structured light images.

According to an embodiment of the present disclosure, the plurality of structured light images may comprise at least 100 images captured at different focal depths.

According to an embodiment of the present disclosure, the workpiece may be disposed on a stage, capturing the plurality of structured light images of the workpiece using the imaging assembly may comprise: moving the stage to adjust a distance of the imaging assembly relative to the workpiece; and capturing a structured light image of the workpiece using the imaging assembly at each distance to obtain a plurality of structured light images at different focal depths.

According to an embodiment of the present disclosure, generating the cross-sectional image of the workpiece based on the plurality of structured light images may comprise: defining a section plane through the workpiece, wherein the section plane intersects each of the plurality of structured light images; determining a focus score for each pixel of the plurality of structured light images intersected by the section plane, wherein the focus score corresponds to a reflection of the structured light pattern reflected by the workpiece at a corresponding focal depth; and combining the focus score of each pixel in the section plane to generate the cross-sectional image of the workpiece.

According to an embodiment of the present disclosure, combining the focus score of each pixel in the section plane to generate the cross-sectional image of the workpiece may comprise: comparing the focus score of each pixel in the section plane to a preset threshold, wherein the preset threshold is greater than or equal to zero; filling each pixel of the section plane having a focus score greater than the preset threshold with a first color; and filling each pixel of the section plane having a focus score less than the preset threshold with a second color that is different from the first color. The cross-sectional image may be defined by pixels of the first color and pixels of the second color.

According to an embodiment of the present disclosure, combining the focus score of each pixel in the section plane to generate the cross-sectional image of the workpiece may further comprise: classifying each pixel of the section plane having a focus score greater than the preset threshold as being at an interface between layers of the multilayer structure; and assigning the first color based on classification of the interface between layers.

According to an embodiment of the present disclosure, the workpiece may be a flat panel display.

Another embodiment of the present disclosure provides a non-transitory computer-readable storage medium comprising instructions stored thereon, which, when executed by a processor, cause the processor to: control a structured light assembly to project a structured light pattern onto a workpiece, wherein the workpiece is a multilayer structure; control an imaging assembly to capture a plurality of structured light images of the workpiece, wherein each of the plurality of structured light images is captured with the imaging assembly being focused at a different height relative to the workpiece; and generate a cross-sectional image of the workpiece based on the plurality of structured light images received from the imaging assembly.

According to an embodiment of the present disclosure, the workpiece may be disposed on a stage, and the processor may be further caused to: send instructions to move the stage to adjust a distance of the imaging assembly relative to the workpiece; and capture a structured light image of the workpiece using the imaging assembly at each distance to obtain a plurality of structured light images at different focal depths.

According to an embodiment of the present disclosure, the processor may be further caused to: define a section plane through the workpiece, wherein the section plane intersects each of the plurality of structured light images; determine a focus score for each pixel of the plurality of structured light images intersected by the section plane, wherein the focus score corresponds to a reflection of the structured light pattern reflected by the workpiece at a corresponding focal depth; and combine the focus score of each pixel in the section plane to generate the cross-sectional image of the workpiece.

According to an embodiment of the present disclosure, the processor may be further caused to: compare the focus score of each pixel in the section plane to a preset threshold, wherein the preset threshold is greater than or equal to zero; fill each pixel of the section plane having a focus score greater than the preset threshold with a first color; and fill each pixel of the section plane having a focus score less than the preset threshold with a second color that is different from the first color. The cross-sectional image is defined by pixels of the first color and pixels of the second color.

According to an embodiment of the present disclosure, the processor may be further caused to: classify each pixel of the section plane having a focus score greater than the preset threshold as being at an interface between layers of the multilayer structure; and assign the first color based on classification of the interface between layers.

Another embodiment of the present disclosure provides a system comprising a structured light assembly, an imaging assembly, and a processor in electronic communication with the structured light assembly and the imaging assembly. The structured light assembly may be configured to project a structured light pattern onto a workpiece, wherein the workpiece is a multilayer structure. The imaging assembly may be configured to capture a plurality of structured light images of the workpiece, wherein each of the plurality of structured light images is captured with the imaging assembly being focused at a different height relative to the workpiece. The processor may be configured to generate a cross-sectional image of the workpiece based on the plurality of structured light images received from the imaging assembly.

According to an embodiment of the present disclosure, the workpiece may be disposed on a stage, and the processor may be further configured to: send instructions to move the stage to adjust a distance of the imaging assembly relative to the workpiece; and capture a structured light image of the workpiece using the imaging assembly at each distance to obtain the plurality of structured light images at different focal depths.

According to an embodiment of the present disclosure, the processor may be further configured to: define a section plane through the workpiece, wherein the section plane intersects each of the plurality of structured light images; determine a focus score for each pixel of the plurality of structured light images intersected by the section plane, wherein the focus score corresponds to a reflection of the structured light pattern reflected by the workpiece at a corresponding focal depth; and combine the focus score of each pixel in the section plane to generate the cross-sectional image of the workpiece.

According to an embodiment of the present disclosure, the processor may be further configured to: compare the focus score of each pixel in the section plane to a preset threshold, wherein the preset threshold is greater than or equal to zero; fill each pixel of the section plane having a focus score greater than the preset threshold with a first color; and fill each pixel of the section plane having a focus score less than the preset threshold with a second color that is different from the first color. The cross-sectional image may be defined by pixels of the first color and pixels of the second color.

According to an embodiment of the present disclosure, the processor may be further configured to: classify each pixel of the section plane having a focus score greater than the preset threshold as being at an interface between layers of the multilayer structure; and assign the first color based on classification of the interface between layers.

### DESCRIPTION OF THE DRAWINGS

For a fuller understanding of the nature and objects of the disclosure, reference should be made to the following detailed description taken in conjunction with the accompanying drawings, in which:

FIG. 1 is a diagram of a system according to an embodiment of the present disclosure;

FIG. 2 is a perspective view of an exemplary workpiece of the present disclosure;

FIG. 3A is a cross-sectional view of the exemplary workpiece of FIG. 2;

FIG. 3B is an exemplary cross-sectional image generated by embodiments of the present disclosure corresponding to the cross-section of FIG. 3A;

FIG. 4 is a flowchart of a method according to an embodiment of the present disclosure;

FIG. 5 is a flowchart of a method according to another embodiment of the present disclosure;

FIG. 6 is a flowchart of a method according to another embodiment of the present disclosure; and

FIG. 7 is a flowchart of a method according to another embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

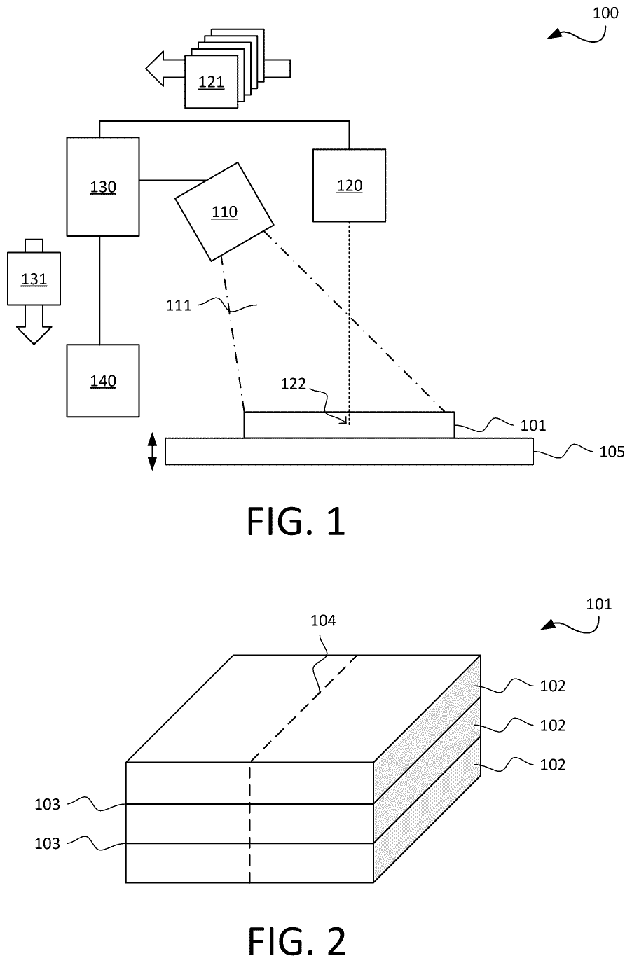

An embodiment of the present disclosure provides a system 100. With reference to FIG. 1, the system 100 may comprise a structured light assembly 110, an imaging assembly 120, and a processor 130 in electronic communication with the structured light assembly 110 and the imaging assembly 120.

The structured light assembly 110 may be configured to project a structured light pattern 111 onto a workpiece 101. The workpiece 101 may be a multilayer structure. For example, as shown in FIG. 2, the workpiece 101 may comprise a plurality of layers 102, with interfaces 103 between each layer. Each of the layers 102 may be transparent or semi-transparent, such that the structured light pattern 111 is transmissible through the workpiece 101. In some embodiments, the workpiece 101 may be a flat panel display. For example, the workpiece 101 may comprise an organic light emitting diode (OLED) or an OLED on silicon panel. The structured light assembly 110 may comprise a light source and a pattern generator disposed in the optical path of the light source. The light source may be a lamp, a fiber coupled light, an LED light, or a laser. By projecting light from the light source through the pattern generator, the structured light pattern 111 may be produced. The pattern generator may be mechanical or electronic. For example, a mechanical pattern generator may be a patterned article comprising a piece of patterned photographic film or patterned glass. An electronic pattern generator may be a liquid crystal pattern generator (LCPG), which is capable of generating different patterns. The patterned article or LCPG may have high contrast, a regular or random pattern, semi-transparent features, and a minimum feature size that corresponds to a sampling resolution of the imaging assembly 120. In some embodiments, the imaging assembly 120 may comprise an array of light sources which form the structured light pattern 111 without the use of a separate pattern generator. In any arrangement, the structured light pattern 111 produced by the structured light assembly 110 may be a grid or other patterns and is not limited herein. The structured light assembly 110 may further comprise one or more optical elements, such as lenses, beam splitters, mirrors, filters, microscope objectives, etc., disposed in the optical path of the light source.

The imaging assembly 120 may be configured to capture a plurality of structured light images 121 of the workpiece 101. The imaging assembly 120 may comprise a charge coupled device (CCD) or complementary metal oxide semiconductor (CMOS) camera. Each of the plurality of structured light images 121 may be captured with the imaging assembly 120 being focused at a different height relative to the workpiece 101. A differential between each focal depth 122 may depend on the thickness of the workpiece 101 and the resolution of the imaging assembly 120. In some embodiments, the differential between each focal depth 122 may be a few tens of nm for a workpiece 101 having a thickness of a few tens of microns. In other words, the differential between each focal depth 122 may be one hundredth, one thousandth, or any other deviation of the thickness of the workpiece 101. It should be understood that reducing the differential between each focal depth 122 may capture more data but may multiply the number of images needed to encompass the thickness of the workpiece 101. In some embodiments, the plurality of structured light images 121 may comprise at least 100 images. The imaging assembly 120 may be configured to capture images at 800 frames per second or more, depending on the maximum speed of the camera sensor of the imaging assembly 120. The imaging assembly 120 may further comprise one or more optical elements, such as lenses, beam splitters, mirrors, filters, microscope objectives, etc., disposed in the optical path of the camera. The optical elements may be configured to adjust the focal length, magnification, working distance, and/or numerical aperture of the imaging assembly 120. For example, the focal depth 122 may be set based on the arrangement of optical elements of the imaging assembly 120. Depending on the magnification of the imaging assembly 120, the field of view of the camera may encompass the entire workpiece 101 or only a portion of the workpiece 101.

The processor 130 may be configured to generate a cross-sectional image 131 of the workpiece 101 based on the plurality of structured light images 121 received from the imaging assembly 120. For example, the cross-sectional image 131 may be generated using data corresponding to reflection of the structured light pattern 111 on the workpiece 101 at varying focal depths 122 using the plurality of structured light images 121. The processor 130 may include a microprocessor, a microcontroller, or other devices.

The processor 130 may be coupled to the components of the system 100 in any suitable manner (e.g., via one or more transmission media, which may include wired and/or wireless transmission media) such that the processor 130 can receive output. The processor 130 may be configured to perform a number of functions using the output. An inspection tool can receive instructions or other information from the processor 130. The processor 130 optionally may be in electronic communication with another inspection tool, a metrology tool, a repair tool, or a review tool (not illustrated) to receive additional information or send instructions.

The processor 130 may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 130 may be disposed in or otherwise part of the system 100 or another device. In an example, the processor 130 and may be part of a standalone control unit or in a centralized quality control unit. Multiple processors 130 may be used, defining multiple subsystems of the system 100.

The processor 130 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 130 to implement various methods and functions may be stored in readable storage media, such as a memory.

If the system 100 includes more than one subsystem, then the different processors 130 may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 130 may be configured to perform a number of functions using the output of the system 100 or other output. For instance, the processor 130 may be configured to send the output to an electronic data storage unit or another storage medium. The processor 130 may be further configured as described herein.

The processor 130 may be configured according to any of the embodiments described herein. The processor 130 also may be configured to perform other functions or additional steps using the output of the system 100 or using images or data from other sources.

The processor 130 may be communicatively coupled to any of the various components or sub-systems of system 100 in any manner known in the art. Moreover, the processor 130 may be configured to receive and/or acquire data or information from other systems (e.g., inspection results from an inspection system such as a review tool, a remote database including design data and the like) by a transmission medium that may include wired and/or wireless portions. In this manner, the transmission medium may serve as a data link between the processor 160 and other subsystems of the system 100 or systems external to system 100. Various steps, functions, and/or operations of system 100 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random-access memory, a magnetic or optical disk, a non-volatile memory, a solid-state memory, a magnetic tape, and the like. A carrier medium may include a transmission medium such as a wire, cable, or wireless transmission link. For instance, the various steps described throughout the present disclosure may be carried out by a single processor 130 (or computer subsystem) or, alternatively, multiple processors 130 (or multiple computer subsystems). Moreover, different sub-systems of the system 100 may include one or more computing or logic systems. Therefore, the above description should not be interpreted as a limitation on the present disclosure but merely an illustration.

In some embodiments, the system 100 may further comprise a stage 105. The workpiece 101 may be disposed on the stage 105. The stage 105 may be movable relative to the imaging assembly 120. For example, the stage 105 may include one or more actuators or motors configured to move the stage 105 in plane (e.g., X and Y directions) and in the depth direction (e.g., Z direction). The processor 130 may be further configured to send instructions to move the stage 105 to adjust the distance of the imaging assembly 120 relative to the workpiece 101, thereby changing the position of the focal depth 122 within the workpiece 101. For example, the stage 105 may move in increments (in the Z direction) based on the differential between focal depths 122 set by the processor 130. Alternatively, the imaging assembly 120 may be movable relative to the stage 105, and the imaging assembly 120 (or the optical elements thereof) may move in increments based on the differential between focal depths 122 set by the processor 130. The processor 130 may be further configured to send instructions to move the stage 105 or the imaging assembly 120 in the X or Y directions to scan the workpiece 101 relative to the imaging assembly 120. The processor 130 may be further configured to send instructions to the imaging assembly 120 to capture a structured light image of the workpiece 101 at each distance to obtain the plurality of structured light images 121 corresponding to each focal depth 122. In some embodiments where the field of view of the camera only covers a portion of the workpiece 101, the processor 130 may be further configured to send instructions to the imaging assembly 120 to capture a structured light image of the workpiece 101 after movement of the stage 105 to different X-Y positions at each distance in the Z direction. Each of the plurality of structured light images 121 may be separately transmitted to the processor 130 after being captured, or the imaging assembly 120 may transmit the plurality of structured light images 121 to the processor 130 after imaging at each distance for the focal depths 122 within the height of the workpiece 101.

In some embodiments, the processor 130 may be further configured to define a section plane 104 through the workpiece 101. The section plane 104 may intersect each of the plurality of structured light images 121. As shown in FIG. 2, the section plane 104 may be perpendicular to the workpiece 101 in the height direction and the width direction. However, the section 104 may be angled relative to the workpiece 101 and is not limited herein. The position and orientation of the section plane 104 may be preset by the processor 130 or may be selected by a user. For example, the section plane 104 may be placed at a preset area of interest of the workpiece 101 or placed based on feedback from the plurality of structured light images 121 (e.g., where a defect is present in the workpiece 101). The processor 130 may be further configured to determine a focus score of each pixel of the plurality of structured light images 121 intersected by the section plane 104. In other words, each of the plurality of structured light images 121 may be divided into an array of pixels, and the processor 130 may select the pixels that are intersected by the section plane 104 for processing. The remaining pixels may be ignored for processing efficiency, or the processor 130 may also determine a focus score of each remaining pixel to generate a multilayer 3D map of the workpiece 101 based on the plurality of structured light images 121. The focus score may correspond to a reflection of the structured light pattern 111 reflected by the workpiece 101 at a corresponding focal depth 122. The processor 130 may be further configured to combine the focus score of each pixel in the section plane 104 to generate the cross-sectional image 131 of the workpiece 101. For example, using each pixel of the plurality of structured light images 121 and the focus score determined for each pixel, the processor 130 may be configured to combine each pixel into an array of pixels forming the cross-sectional image 131.

In some embodiments, the processor 130 may be further configured to compare the focus score of each pixel in the section plane 104 to a preset threshold. In some embodiments, the preset threshold may be greater than zero or equal to zero. When the focal depth 122 is at an interface 103 between layers 102 of the multilayer structure, the structured light pattern 111 is reflected by the workpiece 101 at the interface 103, and the focus score may be greater than the preset threshold. For example, the structured light pattern 111 may reflect from the interface 103 between layers 102, and the intensity of the reflected light is detected by the imaging assembly 120. The processor 130 may be further configured to classify the types of layers 102 at the interface 103 based on the value of the focus score being greater than the preset threshold. For example, the interface 103 may reflect light differently based on the types/materials of the layers 102 at the interface 103, thereby producing a different focus score that can be used for classification. When the focal depth 122 is within a layer 102 of the multilayer structure, the structured light pattern 111 may be reflected by the workpiece 101 or may be transmitted through the workpiece 101, and the focus score may be less than the preset threshold. For example, the structured light pattern 111 may be transmitted through the layer 102 and not reflect, thereby not being detected by the imaging assembly 120, corresponding to a focus score of zero. Alternatively, the structured light pattern 111 may partially reflect from within the layer 102, but the focus score may be less than the preset threshold. It should be understood that the preset threshold used by the processor 130 may be calibrated for the materials of the workpiece 101 being inspected, for example, based on a range of intensities of the reflection detected by the imaging assembly 120.

In some embodiments, the processor 130 may be further configured to fill each pixel of the section plane 104 having a focus score greater than the preset threshold with a first color 132. The processor 130 may be further configured to fill each pixel of the section plane 104 having a focus score less than the preset threshold with a second color 133 that is different from the first color 132. The cross-sectional image 131 may be defined by the pixels of the first color 132 and the pixels of the second color 133. Accordingly, the cross-sectional image 131 may illustrate the internal structure of the workpiece 101 based on reflection at the interfaces 103 between layers 102 and the presence of any anomalies or defects within the workpiece 101. In embodiments where the processor 130 further classifies the interfaces 103 between layers 102 based on the focus score being above the preset threshold, different classifications may correspond to different colors, and the processor 130 may assign the first color 132 based on the classification of the interface 103 between layers 102. Different classifications may use different colors that are distinguishable from the first color 132 and the second color 133. Accordingly, the cross-sectional image 131 may further illustrate different materials/classifications of the various layers 102 of the workpiece 101 using different colors.

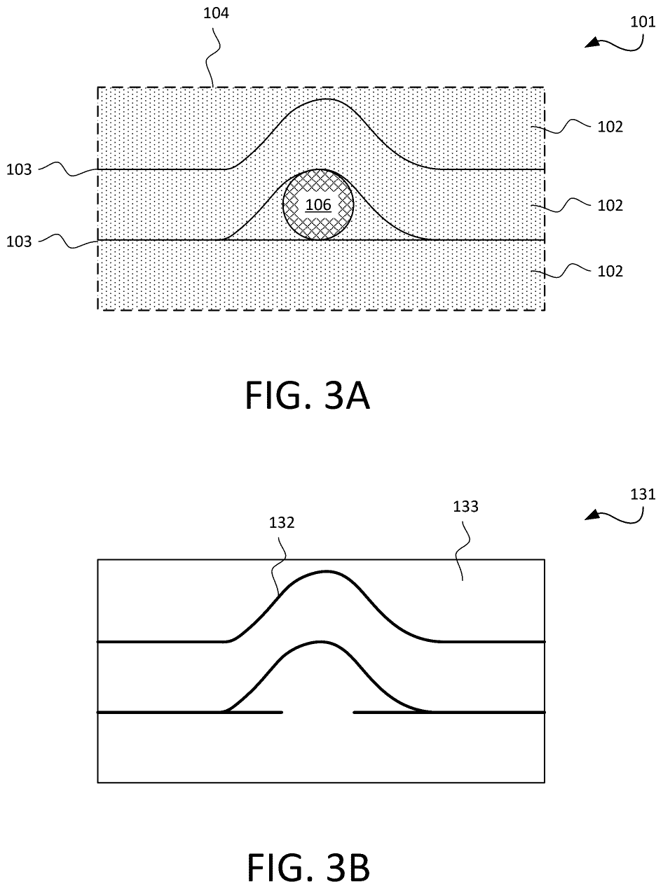

FIG. 3A illustrates a cross-sectional view of the workpiece 101 taken along section plane 104. The workpiece 101 includes three layers 102, with interfaces 103 therebetween. A particle 106 is disposed in one of the interfaces 103 between two of the layers 102. While the particle 106 is illustrated in one of the interfaces 103, it should be understood that the particle 106 may be disposed on top of the uppermost layer 102 or underneath the lowermost layer 102 and is not limited herein. The particle 106 may cause defects in the deposition of the subsequent layers 102, appearing as a shift. The particle 106 may be opaque and may be a different material from the layers 102 of the workpiece 101.

FIG. 3B illustrates an exemplary cross-sectional image 131 of the workpiece generated by the processor 130. The cross-sectional image 131 includes pixels of the first color 132 to indicate the interfaces 103 between layers 102 and pixels of the second color 133 to indicate the areas within each layer 102. While black is used for the first color 132 and white is used for the second color 133, different combinations of distinguishable colors may be used, and is not limited herein. The shifting of the layers 102 due to the defect 106 can be seen in the cross-sectional image 131, based on the pixels of the first color 132. Since the particle 106 may be opaque, the structured light pattern 111 may not transmit through the particle 106, and there may be no reflectivity data for the layers 102 or interfaces 103 beneath. Accordingly, these areas are shown with pixels of the second color 133.

In some embodiments, the processor 130 may be in electronic communication with a display device 140. The processor 130 may be further configured to transmit the cross-sectional image 131 to the display device 140 for display. The display device 140 may be configured to display the pixels of the first color 132 and the pixels of the second color 133 (and any additional colors) to form the cross-sectional image 131.

With the system 100, a cross-sectional image 131 of the workpiece 101 can be generated to identify the internal structure and any defects that may be present therein. The use of a structured light pattern 111 is non-destructive of the workpiece 101 and can produce a cross-sectional image 131 that is comparable to FIB-based imaging.

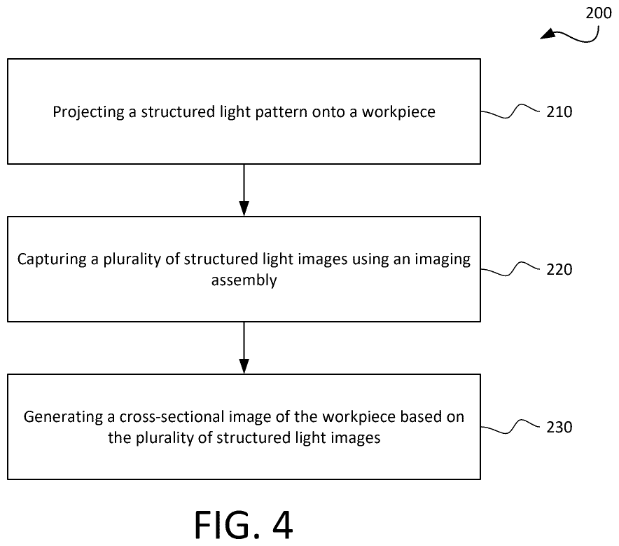

Another embodiment of the present disclosure provides a method 200. With reference to FIG. 4, the method 200 may comprise the following steps.

At step 210, a structured light pattern is projected onto a workpiece. The workpiece may be a multilayer structure. For example, the workpiece may comprise a plurality of layers, with interfaces between each layer. Each of the layers may be transparent or semi-transparent, such that the structured light pattern is transmissible through the workpiece. In some embodiments, the workpiece may be a flat panel display. For example, the workpiece may comprise an OLED or an OLED on silicon panel. The structured light pattern may be produced by a structured light assembly comprising a light source and a pattern generator disposed in the optical path of the light source. The light source may be a lamp, a fiber coupled light, an LED light, or a laser. By projecting light from the light source through the pattern generator, the structured light pattern may be produced. The pattern generator may be mechanical or electronic. For example, a mechanical pattern generator may be a patterned article comprising a piece of patterned photographic film or patterned glass. An electronic pattern generator may be a liquid crystal pattern generator (LCPG), which is capable of generating different patterns. The patterned article or LCPG may have high contrast, a regular or random pattern, semi-transparent features, and a minimum feature size that corresponds to a sampling resolution of the imaging assembly. In some embodiments, the imaging assembly may comprise an array of light sources which form the structured light pattern without the use of a separate pattern generator. In any arrangement, the structured light pattern produced by the imaging assembly may be a grid or other patterns and is not limited herein. The structured light assembly may further comprise one or more optical elements, such as lenses, beam splitters, mirrors, filters, microscope objectives, etc., disposed in the optical path of the light source.

At step 220, a plurality of structured light images of the workpiece are captured using an imaging assembly. The imaging assembly may comprise a charge coupled device (CCD) or complementary metal oxide semiconductor (CMOS) camera. Each of the plurality of structured light images may be captured with the imaging assembly being focused at a different focal depth relative to the workpiece. A differential between each focal depth may depend on the thickness of the workpiece and the resolution of the imaging system. In some embodiments, the differential between each focal depth may be a few tens of nm for workpiece having a thickness of a few tens of microns. In other words, the differential between each focal depth may be one hundredth, one thousandth, or any other deviation of the thickness of the workpiece. It should be understood that reducing the differential between each focal depth may capture more data but may multiply the number of images needed to encompass the thickness of the workpiece. In some embodiments, the plurality of structured light images may comprise at least 100 images. The imaging assembly may be configured to capture images at 800 frames per second or more, depending on the maximum speed of the camera sensor of the imaging assembly. The imaging assembly may further comprise one or more optical elements, such as lenses, beam splitters, mirrors, filters, microscope objectives, etc., disposed in the optical path of the camera. The optical elements may be configured to adjust the focal length, magnification, working distance, and/or numerical aperture of the imaging assembly. For example, the focal depth may be set based on the arrangement of optical elements of the imaging assembly. Depending on the magnification of the imaging assembly, the field of view of the camera may encompass the entire workpiece or only a portion of the workpiece.

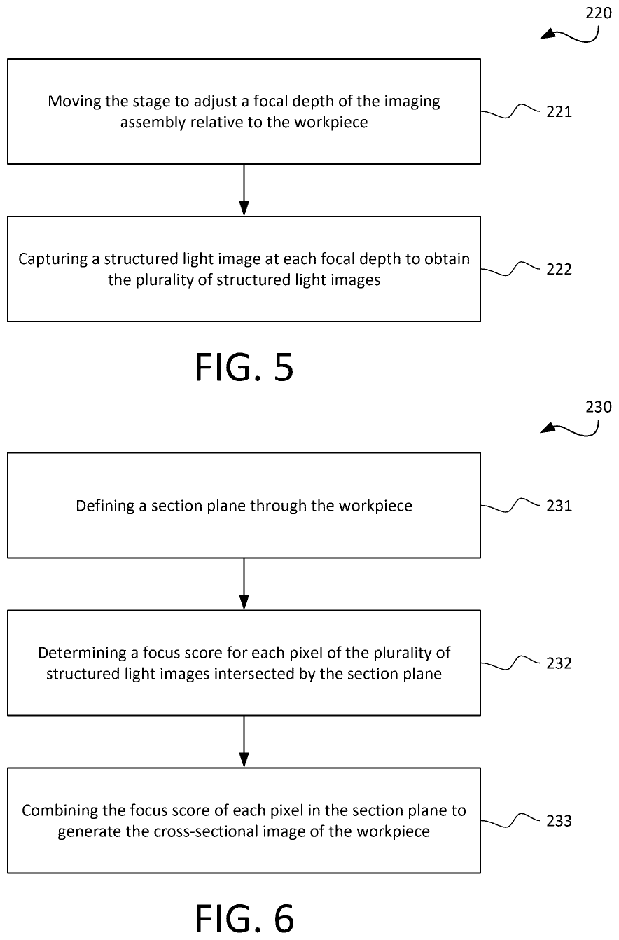

In some embodiments, the workpiece may be disposed on a stage, and step 220 may comprise the following steps shown in FIG. 5.

At step 221, the stage is moved to adjust the distance of the imaging assembly relative to the workpiece. For example, the stage may include one or more actuators or motors configured to move the stage in plane (e.g., X and Y directions) and in the depth direction (e.g., Z direction). The stage may move in increments in the Z direction based on the differential between focal depths set by a processor. Alternatively, the imaging assembly may be movable relative to the stage to adjust the distance of the imaging assembly relative to the workpiece. It should be understood that adjusting the distance between the imaging assembly and the workpiece may change the position of the focal depth of the imaging assembly within the workpiece. The stage may also move in the X or Y direction to scan the workpiece relative to the imaging assembly at each distance.

At step 222, a structured light image of the workpiece is captured using the imaging assembly at each distance to obtain the plurality of structured light images corresponding to each focal depth. In some embodiments where the field of view of the camera only covers a portion of the workpiece, a structured light image of the workpiece may be captured after movement of the stage to different X-Y positions at each distance in the Z direction.

Referring back to FIG. 4, at step 230, a cross-sectional image of the workpiece is generated based on the plurality of structured light images. For example, the cross-sectional image may be generated using data corresponding to reflection of the structured light pattern on the workpiece at varying focal depths using the plurality of structured light images.

In some embodiments, step 230 may comprise the following steps shown in FIG. 6.

At step 231, a section plane is defined through the workpiece. The section plane may intersect each of the plurality of structured light images. The position and orientation of the section plane relative to the workpiece is not limited herein. The position and orientation of the section plane may be preset by a processor or may be selected by a user. For example, the section plane may be placed at a preset area of interest of the workpiece or placed based on feedback from the plurality of structured light images (e.g., where a defect is present in the workpiece).

At step 232, a focus score is determined for each pixel of the plurality of structured light images intersected by the section plane. In other words, each of the plurality of structured light images may be divided into an array of pixels, and the pixels that are intersected by the section plane may be selected for processing. The remaining pixels may be ignored for processing efficiency, or the focus score of the remaining pixels may be determined to generate a multilayer 3D map of the workpiece. The focus score may correspond to a reflection of the structured light pattern reflected by the workpiece at a corresponding focal depth.

At step 233, the focus score of each pixel in the section plane is combined to generate the cross-sectional image of the workpiece. For example, using each pixel of the plurality of structured light images and the focus score determined for each pixel, each pixel can be combined into an array of pixels forming the cross-sectional image.

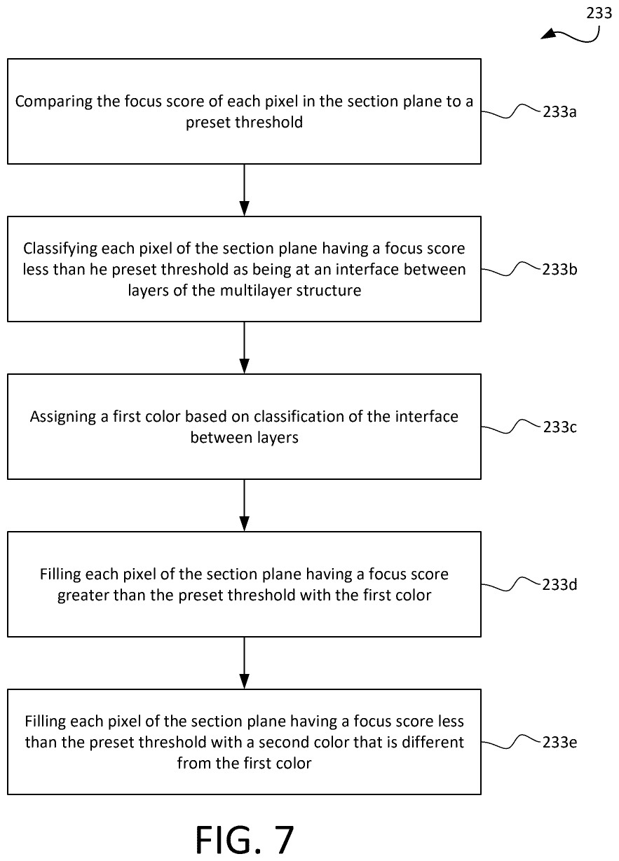

In some embodiments, step 233 may comprise the following steps shown in FIG. 7.

At step 233a, the focus score of each pixel in the section plane is compared to a preset threshold. In some embodiments, the preset threshold may be greater than zero or equal to zero. When the focal depth is at an interface between layers of the multilayer structure, the structure light pattern is reflected by the workpiece at the interface, and the focus score may be greater than the preset threshold. For example, the structured light pattern may reflect from the interface between layers, and the intensity of the reflected light may be detected by the imaging assembly. When the focal depth is within a layer of the multilayer structure, the structured light pattern may be reflected by the workpiece or may be transmitted through the workpiece, and the focus score may be less than the preset threshold. For example, the structured light pattern may be transmitted through the layer and not reflect, thereby not being detected by the imaging assembly, corresponding to a focus score of zero. Alternatively, the structured light pattern may partially reflect from within the layer, but the focus score may be less than the preset threshold. It should be understood that the preset threshold may be calibrated for the materials of the workpiece being inspected, for example, based on a range of intensities of the reflection detected by the imaging assembly.

At step 233b, each pixel in the section plane having a focus score greater than the preset threshold is classified as being an interface between layers of the multilayer structure. Different types of layers can be classified based on the value of the focus score being greater than the preset threshold. For example, the interface may reflect light differently based on the types/materials of the layers at the interface, thereby producing a different focus score that can be used for classification.

At step 233c, a first color is assigned based on the classification of the interface between layers of the multilayer structure. Different colors can be used to identify different types and materials of the layers at the interface. Accordingly, a first color can be assigned based on the classification of the layers at the interface.

At step 233d, each pixel of the section plane having a focus score greater than the preset threshold is filled with the first color.

At step 233e, each pixel of the section plane having a focus score less than the preset threshold is filled with a second color that is different from the first color. Accordingly, the cross-sectional image may be defined by the pixels of the first color and the pixels of the second color. In embodiments where additional values are assigned, each value may correspond to a different color that is distinguishable from the first color and the second color. Accordingly, the cross-sectional image may illustrate the internal structure of the workpiece based on reflection at the interfaces between layers and the presence of any anomalies or defects within the workpiece. In embodiments where the interfaces between layers can be classified based on the focus score being above the preset threshold, different classifications may use different colors that are distinguishable from the first color and the second color. Accordingly, the cross-sectional image may further illustrate different materials/classifications of the various layers of the workpiece using different colors.

With the method 200, a cross-sectional image of the workpiece can be generated to identify the internal structure and any defects that may be present therein. The use of a structured light pattern is non-destructive of the workpiece and can produce a cross-sectional image that is comparable to FIB-based imaging.

Another embodiment of the present disclosure provides a non-transitory computer-readable storage medium. The storage medium may comprise instructions stored thereon, which, when executed by a processor, cause the processor to perform the method 200. For example, the processor may be the processor 130 of the system 100.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A method comprising:
projecting a structured light pattern onto a workpiece, wherein the workpiece is a multilayer structure;
capturing a plurality of structured light images of the workpiece using an imaging assembly, wherein each of the plurality of structured light images is captured with the imaging assembly being focused at a different focal depth relative to the workpiece; and
generating a cross-sectional image of the workpiece based on the plurality of structured light images.

2. The method of claim 1, wherein the plurality of structured light images comprises at least 100 images captured at different focal depths.

3. The method of claim 1, wherein the workpiece is disposed on a stage, and capturing the plurality of structured light images of the workpiece using the imaging assembly comprises:
moving the stage to adjust a distance of the imaging assembly relative to the workpiece; and
capturing a structured light image of the workpiece using the imaging assembly at each distance to obtain a plurality of structured light images at different focal depths.

4. The method of claim 1, wherein generating the cross-sectional image of the workpiece based on the plurality of structured light images comprises:
defining a section plane through the workpiece, wherein the section plane intersects each of the plurality of structured light images;
determining a focus score for each pixel of the plurality of structured light images intersected by the section plane, wherein the focus score corresponds to a reflection of the structured light pattern reflected by the workpiece at a corresponding focal depth; and
combining the focus score of each pixel in the section plane to generate the cross-sectional image of the workpiece.

5. The method of claim 4, wherein combining the focus score of each pixel in the section plane to generate the cross-sectional image of the workpiece comprises:
comparing the focus score of each pixel in the section plane to a preset threshold, wherein the preset threshold is greater than or equal to zero;
filling each pixel of the section plane having a focus score greater than the preset threshold with a first color; and
filling each pixel of the section plane having a focus score less than the preset threshold with a second color that is different from the first color;
wherein the cross-sectional image is defined by pixels of the first color and pixels of the second color.

6. The method of claim 5, wherein combining the focus score of each pixel in the section plane to generate the cross-sectional image of the workpiece further comprises:
classifying each pixel of the section plane having a focus score greater than the preset threshold as being at an interface between layers of the multilayer structure; and
assigning the first color based on classification of the interface between layers.

7. The method of claim 1, wherein the workpiece is a flat panel display.

8. A non-transitory computer-readable storage medium comprising instructions stored thereon, which, when executed by a processor, cause the processor to:
control a structured light assembly to project a structured light pattern onto a workpiece, wherein the workpiece is a multilayer structure;
control an imaging assembly to capture a plurality of structured light images of the workpiece, wherein each of the plurality of structured light images is captured with the imaging assembly being focused at a different height relative to the workpiece; and
generate a cross-sectional image of the workpiece based on the plurality of structured light images received from the imaging assembly.

9. The storage medium of claim 8, wherein the plurality of structured light images comprises at least 100 images captured at different focal depths.

10. The storage medium of claim 8, wherein the workpiece is disposed on a stage, and the processor is further caused to:
send instructions to move the stage to adjust a distance of the imaging assembly relative to the workpiece; and
capture a structured light image of the workpiece using the imaging assembly at each distance to obtain a plurality of structured light images at different focal depths.

11. The storage medium of claim 8, wherein the processor is further caused to:
define a section plane through the workpiece, wherein the section plane intersects each of the plurality of structured light images;
determine a focus score for each pixel of the plurality of structured light images intersected by the section plane, wherein the focus score corresponds to a reflection of the structured light pattern reflected by the workpiece at a corresponding focal depth; and
combine the focus score of each pixel in the section plane to generate the cross-sectional image of the workpiece.

12. The storage medium of claim 11, wherein the processor is further caused to:
compare the focus score of each pixel in the section plane to a preset threshold, wherein the preset threshold is greater than or equal to zero;
fill each pixel of the section plane having a focus score greater than the preset threshold with a first color; and
fill each pixel of the section plane having a focus score less than the preset threshold with a second color that is different from the first color;
wherein the cross-sectional image is defined by pixels of the first color and pixels of the second color.

13. The storage medium of claim 12, wherein the processor is further caused to:
classify each pixel of the section plane having a focus score greater than the preset threshold as being at an interface between layers of the multilayer structure; and
assign the first color based on classification of the interface between layers.

14. A system comprising:
a structured light assembly configured to project a structured light pattern onto a workpiece, wherein the workpiece is a multilayer structure;
an imaging assembly configured to capture a plurality of structured light images of the workpiece, wherein each of the plurality of structured light images is captured with the imaging assembly being focused at a different height relative to the workpiece; and
a processor in electronic communication with the structured light assembly and the imaging assembly, wherein the processor is configured to generate a cross-sectional image of the workpiece based on the plurality of structured light images received from the imaging assembly.

15. The system of claim 14, wherein the plurality of structured light images comprises at least 100 images captured at different focal depths.

16. The system of claim 14, wherein the workpiece is disposed on a stage, and the processor is further configured to:
send instructions to move the stage to adjust a distance of the imaging assembly relative to the workpiece; and
capture a structured light image of the workpiece using the imaging assembly at each distance to obtain the plurality of structured light images at different focal depths.

17. The system of claim 14, wherein the processor is further configured to:
define a section plane through the workpiece, wherein the section plane intersects each of the plurality of structured light images;
determine a focus score for each pixel of the plurality of structured light images intersected by the section plane, wherein the focus score corresponds to a reflection of the structured light pattern reflected by the workpiece at a corresponding focal depth; and
combine the focus score of each pixel in the section plane to generate the cross-sectional image of the workpiece.

18. The system of claim 17, wherein the processor is further configured to:
compare the focus score of each pixel in the section plane to a preset threshold, wherein the preset threshold is greater than or equal to zero;
fill each pixel of the section plane having a focus score greater than the preset threshold with a first color; and
fill each pixel of the section plane having a focus score less than the preset threshold with a second color that is different from the first color;
wherein the cross-sectional image is defined by pixels of the first color and pixels of the second color.

19. The system of claim 18, wherein the processor is further configured to:
classify each pixel of the section plane having a focus score greater than the preset threshold as being at an interface between layers of the multilayer structure; and
assign the first color based on classification of the interface between layers.

20. The system of claim 14, wherein the workpiece is a flat panel display.
